(19) United States
(12) Patent Application Publication
(10) Pub. No.: US 2007/0079135 A1
(43) Pub. Date: Apr. 5, 2007

(54) User authentication system and user authentication method

(75) Inventor: William H. Saito, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FORVAL TECHNOLOGY, INC., Tokyo (JP)

(21) Appl. No.: 11/540,535

(22) Filed: Oct. 2, 2006

Related U.S. Application Data
(60) Provisional application No. 60/722,990, filed on Oct. 4, 2005.

(51) Int. Cl. H04L 9/32; G06F 12/14; H04L 9/00; H04K 1/00; G06K 9/00; G06F 17/30; G06F 12/00; G06F 7/04; G06F 13/00; G06F 7/58; G06K 19/00; G11C 7/00

(52) U.S. Cl. 713/183; 713/184; 726/2; 726/17

(57) ABSTRACT

A user authentication system capable of maintaining high-level security and of reducing a user's load of operations necessary for login is provided. The user authentication system includes a user terminal, a mobile phone, a password issuing unit, and a service providing unit. When a user accesses the system via the user terminal, the service providing unit encodes connection information of the password issuing unit into a code, and sends the encoded code to the user terminal. The mobile phone decodes the code displayed on the user terminal, and accesses the password issuing unit using the connection information. The password issuing unit generates a one-time password, and sends the one-time password to the service providing unit and also to the mobile phone. The user terminal sends the one-time password displayed on the mobile phone and user identification information to the service providing unit. When the service providing unit determines that the two one-time passwords each sent from the user terminal and the password issuing unit are identical, the service providing unit permits the access of the user via the user terminal.

### CROSS REFERENCE TO RELATED APPLICATIONS

The present application claims the benefit of Provisional Patent Application No. 60/722,990 filed on Oct. 4, 2005.

### BACKGROUND OF THE INVENTION

1. Field of the Invention

The present invention relates to a user authentication technology on the Internet, and more specifically, to a user authentication system capable of maintaining security strength and of reducing a user's load of operations necessary for login, and the user authentication method.

2. Description of the Related Art

As a representative method for conducting authentication in a system in which a user is permitted to access the system only after the user is authenticated, the method has been known in which a user enters a user name and a password registered in advance from a user terminal thereof, the user name and the password are subjected to verification in the system, and, when the user name and the password make a valid combination, the access of the user is permitted.

To ensure security, the authentication method described above is designed to make an accidental coincidence of a password difficult to happen, even if a random combination of alphabets and numerals is entered as a password. For example, a lengthy password or a complicated password with capital letters and small letters mixed therein may be used in the authentication method. Additionally or alternatively, a valid period of a password may be made short to prevent a stolen password from being misused.

Another authentication system has been also realized in which a hardware token is inserted in a USB (Universal Serial Bus) port, and an ID (Identification) stored in the hardware token is read out for authentication.

In the former authentication system, however, when a password is made complicated or is changed on a regular basis to ensure security, there has been a problem that a user may forget a password or may write a password on paper as a reminder, which could undermine security.

In the latter authentication system, the hardware token is cumbersome to use, because a user may lose the hardware token, or has to replace a battery thereof on some regular basis.

In the light of the problems described above, “SecureCall” by Third Networks Co., Ltd. (Internet searched on Aug. 16, 2005) URL: http://www.thirdnetworks.co.jp/sc/03ser02.html discloses a user authentication system in which, when a user logs in from a terminal, an authentication server calls back to a mobile phone or the like of the user via a telephone network to conduct an additional authentication, and, only when the authentication via the mobile phone as well as via the terminal is successfully conducted, the user is permitted to access the system.

In the user authentication system described in the “SecureCall”, in the meantime, a user needs to keep in mind a combination of a user ID (Identifier) and a password to be entered from a terminal, and a password to be entered from a mobile phone. Accordingly, there is also a possibility that a user may forget a password(s), making it impossible for the user to log in the system.

The present invention has been made to solve the problems described above, and an object of the present invention is to provide a user authentication system and method capable of maintaining high-level security and of reducing a user's load of operations necessary for login.

### SUMMARY OF THE INVENTION

The user authentication system according to the present invention comprises a user terminal for entering information data for user authentication; a mobile phone for decoding a code; a password issuing unit for generating a one-time password; and a service providing unit for providing service to the user terminal and conducting operations for user authentication, which are connected to each other. The user authentication system is characterized in that, when the user attempts access to the system via the user terminal, the service providing unit generates an encoded code containing connection information of the password issuing unit; and sends the code to the user terminal: the mobile phone decodes the code displayed on the user terminal; and accesses the password issuing unit using the connection information: the password issuing unit generates a random one-time password; and sends the one-time password to the service providing unit and also to the mobile phone accessing the password issuing unit: the user terminal obtains the one-time password displayed on the mobile phone and user identification information for identifying the user; and sends the one-time password and the user identification information to the service providing unit as data of authentication information: the service providing unit compares the one-time password sent from the user terminal with the one-time password sent from the password issuing unit; when the two passwords are identical, the service providing unit authenticates the access as that from the user related to the user identification information; and permits the access of the user via the user terminal.

### BRIEF DESCRIPTION OF THE DRAWINGS

FIG. 1 is a schematic block diagram illustrating the user authentication system.

FIG. 2 is an example of information data contained in the user management information.

FIG. 3 is an example of information data contained in the mobile phone management information.

FIG. 4A and 4B are sequence diagrams each illustrating operations in the user authentication system.

FIG. 5 is a view showing an example of an authentication screen.

### DETAILED DESCRIPTION OF EXEMPLARY EMBODIMETNS

Embodiments of the present invention are described next in detail with reference to the accompanying drawings.

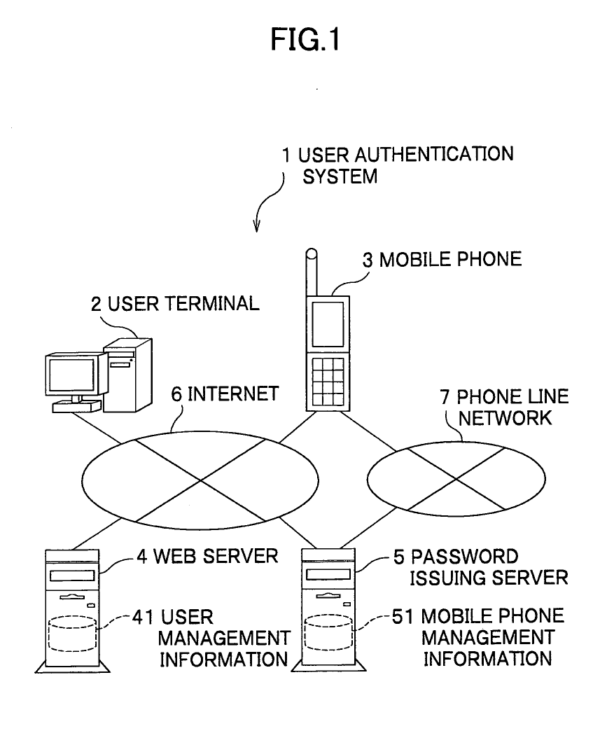

FIG. 1 is a schematic block diagram according to an embodiment. As shown in FIG. 1, a user authentication system 1 according to this embodiment comprises a user terminal 2 to be used by a user; a mobile phone to be used by the user 3; a Web server 4 to which the user wants to log in; and a password issuing server 5 for mediating operations for authentication of the user terminal 2 and the Web server 4, which are connected to each other via the Internet 6.

In addition, the mobile phone 3 and the password issuing server 5 are also connected to each other via a telephone network 7.

(User Terminal)

The user terminal 2 is a terminal unit used by a user to connect to the Internet 6 to receive service, and comprises a RAM (Random Access Memory), a ROM (Read Only Memory) and a hard disk drive; a CPU (Central Processing Unit); a mouse and a keyboard; a display; and a LAN (Local Area Network) card. The user terminal 2 is embodied by, for example, a personal computer.

Besides an OS (Operating System), a Web browser software is installed in the ROM and/or the hard disk of the user terminal 2, and, when such software is deployed in the RAM and executed by a CPU, the user terminal 2 operates as a terminal unit connectable to the Internet 6.

(Mobile Phone)

The mobile phone 3 is used for obtaining a one-time password, and comprises a RAM and a ROM, a CPU, a numeric keypad, a display, a communication circuit, and a camera for capturing images. The ROM in the mobile phone 3 stores therein a program for exercising centralized control over functions of the mobile phone 3, image data used in the mobile phone 3 and a browser program for Web browsing. Operation information generated by entering data from the numeric keypad is input into the CPU, based on which the CPU generates image information data to output the same on the display.

The mobile phone 3 according to this embodiment has a function of decoding a two-dimensional code contained in an image captured by the camera. This function is embodied when the CPU executes a software stored in the ROM of the mobile phone 3.

In this embodiment, it is to be noted that, to simplify the description, FIG. 1 shows that the mobile phone 3 is seemingly connected directly to the Internet 6, however, the mobile phone 3 is actually connected to the telephone network 7, and, via a gateway not shown and connected to the telephone network 7, the mobile phone 3 is finally connected to the Internet 6.

(Web Server)

The Web server 4 is a unit for providing a user with service on the Internet 6, and comprises a RAM, a ROM and a hard disk drive; a CPU; and a LAN card. The Web server 4 is embodied by, for example, a server computer.

The hard disk drive in the Web server 4 stores therein a service program for providing service, a user authentication program for conducting operations for user authentication using a one-time password, and user management information 41 with information data concerning users contained therein.

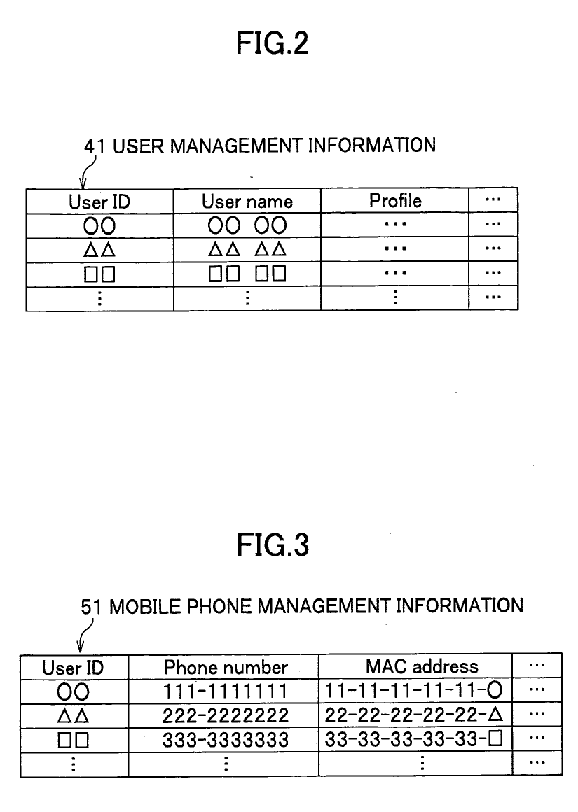

FIG. 2 is a table showing an example of information data contained in the user management information 41. As shown in FIG. 2, the user management information 41 stores therein information data concerning the users who can use the service provided by the Web server 4. The user management information 41 contains therein a user name, a user profile used in the Web server 4 and the like each associated with a user ID unique to each user.

Data in the user management information 41 is registered in advance by, for example, an administrator of the Web server 4, before a user uses the user authentication system 1.

The Web server 4 herein corresponds to the service providing unit described in Claims. The user ID corresponds to the user identification information described in Claims.

(Password Issuing Server)

The password issuing server 5 is a unit like the Web server 4, and comprises a RAM, a ROM and a hard disk drive; a CPU; and a LAN card. The password issuing server 5 is embodied by, for example, a server computer.

The hard disk drive in the password issuing server 5 stores therein mobile phone management information 51 containing information data for identifying the mobile phone 3 used by a user, and a password issuing program for issuing a random one-time password. When the password issuing server 5 is accessed by a user via the mobile phone 3 thereof, the one-time password issuing program issues a one-time password, and transmits the one-time password to the mobile phone 3 via the telephone network 7.

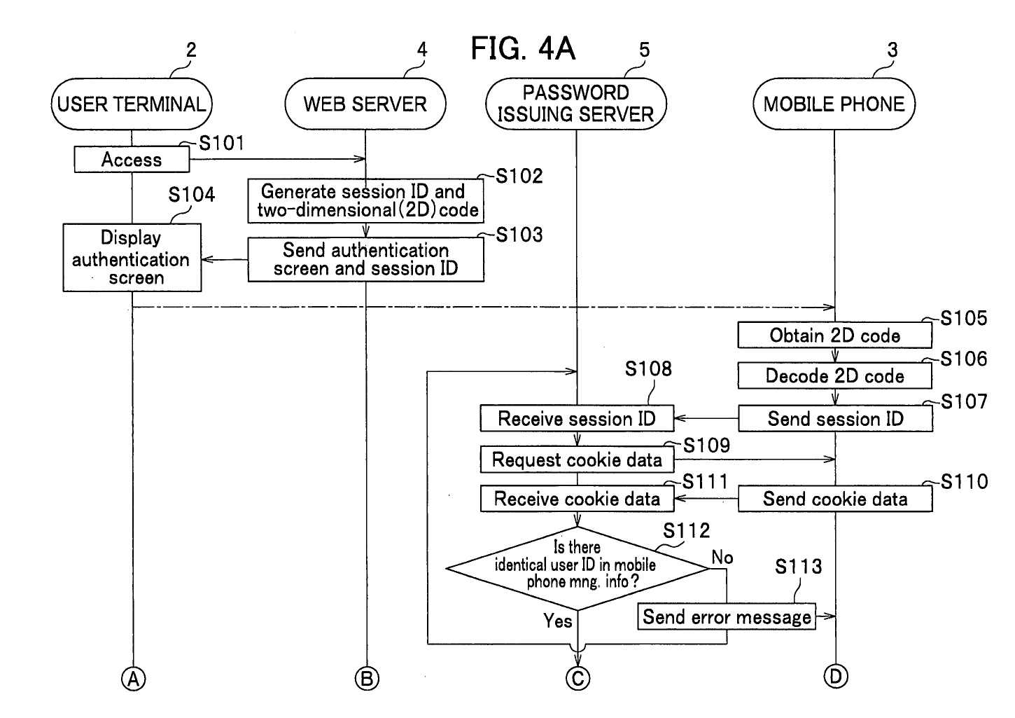

FIG. 3 is a table showing an example of information data contained in the mobile phone management information 51. As shown in FIG. 3, the mobile phone management information 51 contains a phone number, a MAC (Media Access Control) address and the like each associated with a user ID unique to each user of the mobile phone 3. In addition, the mobile phone management information 51 may contain therein an ESN (Electronic Serial Number) of the mobile phone 3.

Data in the mobile phone management information 51 is registered in advance by, for example, an administrator of the password issuing server 5, before a user uses the user authentication system 1.

It is to be noted that the password issuing server 5 herein corresponds to the password issuing unit described in Claims.

(Operations In the User Authentication System)

In the user authentication system 1, operations for authentication are conducted using a user ID which the user keeps in mind and enters from the user terminal 2, cookie data of the mobile phone 3, and a one-time password issued by the password issuing server 5.

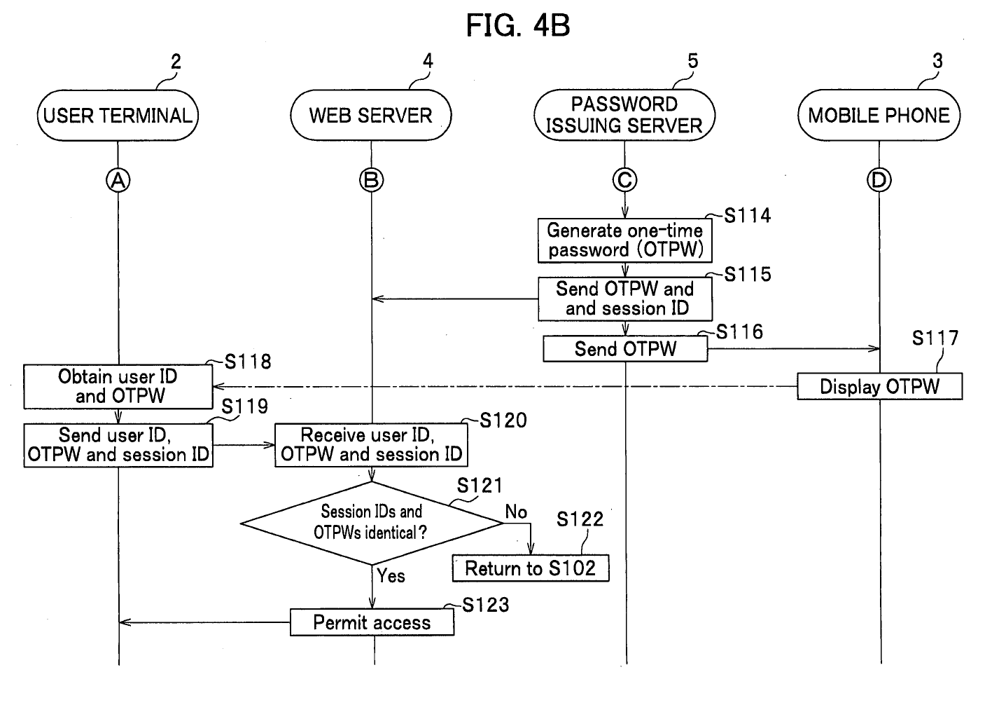

Next, operations in the user authentication system 1 according to this embodiment are described in detail with reference to FIG. 4A and FIG. 4B, each of which is a sequence diagram illustrating operations in the user authentication system 1.

In the user authentication system 1 according to this embodiment, it is to be noted that communications between each component via the Internet 6 are performed by means of, for example, an encrypted communication using the SSL (Secure Socket Layer).

First, a user who wants to use service provided by the Web server 4 accesses the Web server 4 from the user terminal 2 (step S101). In response to this operation, the Web server 4 generates a session ID (a) and a two-dimensional code (step S102). Herein, the session ID (a) is information data for identifying a session between the user terminal 2 and the Web server 4. The two-dimensional code is an encoded code containing information data such as an address of the password issuing server 5, the session ID (a), the time when the two-dimensional code is generated, a public key for an encrypted communication in a session between the mobile phone 3 and the password issuing server 5 to be hereinafter described, a random number for authentication, and a valid period of a packet. The two-dimensional code is generated every time the user accesses the Web server 4 via the user terminal 2.

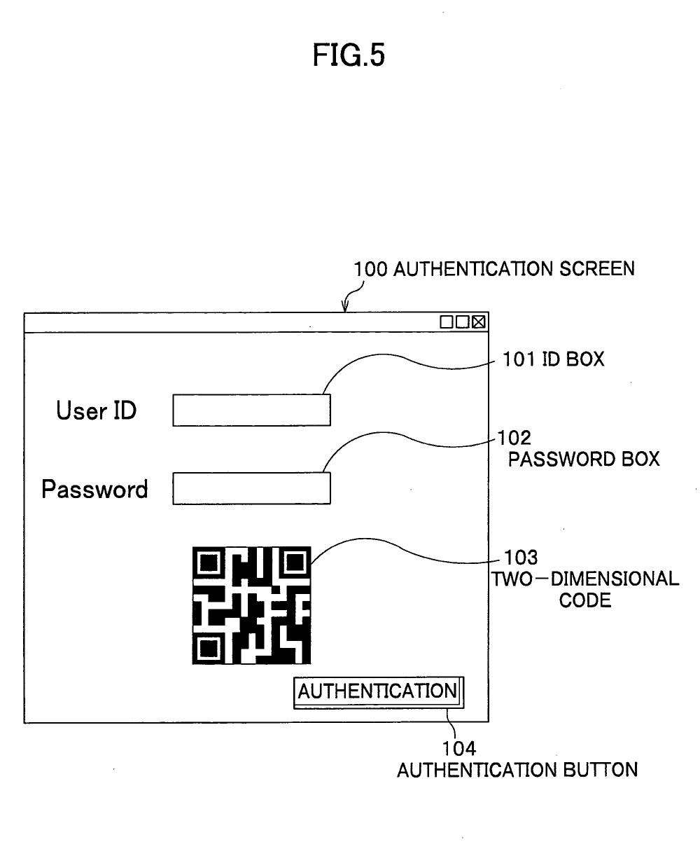

The Web server 4 sends an authentication screen containing the two-dimensional code and the session ID (a) to the user terminal 2 (step S103). FIG. 5 is herein an example of an authentication screen sent by the Web server 4. The authentication screen 100 shown in FIG. 5 displays an ID box 101 into which a user enters a user ID, a password box 102 into which the user enters a password, and a two-dimensional code 103, as well as an authentication button 104 on which the user clicks to obtain authentication on the bottom right of the screen 100.

It is to be noted that the information data encoded into a two-dimensional code does not include a user ID.

Next, the user terminal 2 displays the received authentication screen 100 on the display thereof (step S104) The user then captures the two-dimensional code 103 displayed on the authentication screen 100 with the camera-equipped mobile phone 3. With this operation, the mobile phone 3 obtains the two-dimensional code 103 (step S105), and decodes the two-dimensional code 103 (step S106). Then the mobile phone 3 accesses the password issuing server 5 using the address of the password issuing server 5 contained in the decoded information data, and sends the session ID (a) contained in the decoded information data (step S107).

When the password issuing server 5 receives the session ID (a) (step S108), the password issuing server 5 requests the mobile phone 3 to send the cookie data (step S109).

The mobile phone 3 requested to send the cookie data sends the cookie data to the password issuing server 5 (step S110) The cookie data herein contains the MAC address, the phone number, the ESN and the session ID (b) of the mobile phone 3.

The session ID (b) is herein information data for identifying a session between the mobile phone 3 and the password issuing server 5.

It is to be noted that the MAC address, the phone number and the ESN correspond to the mobile phone identification information described in Claims.

When the password issuing server 5 receives the cookie data from the mobile phone 3 (step S111), the password issuing server 5 verifies the cookie data with the MAC address, the phone number, the ESN and the like of the mobile phone 3 registered in the mobile phone management information 51 to determine whether there is any identical user ID in the mobile phone management information 51 or not (step S112).

When there is no identical user ID in the mobile phone management information 51 (‘No’ in step S112), the password issuing server 5 sends to the mobile phone 3 an error message saying, for example, “Not a registered mobile phone” (step S113), and the process returns to step S108 so that the password issuing server 5 can receive possible access from other mobile phone 3.

Then, moving to FIG. 4B, when there is an identical user ID in the mobile phone management information 51 (‘Yes’ in step S112), the password issuing server 5 randomly generates a one-time password (step S114), and sends the one-time password and the session ID (a) of the Web server 4 received in step S106 to the Web server 4 (step S115).

The password issuing server 5 then sends the one-time password generated in step S112 also to the mobile phone 3 (step S116). In this step, it is preferable that the password issuing server 5 sends the one-time password to the mobile phone 3 using the short message service provided by a mobile phone company via the telephone network 7. This is because the phone number contained in the cookie data can be checked. Alternatively, the same effect can be achieved in the configuration in which the password issuing server 5 is provided with a voice synthesizer to call back to the mobile phone 3 via the telephone network 7 to send a one-time password by means of synthesized voice.

It is also possible that the one-time password is sent to the mobile phone 3 via the Internet 6.

Next, the mobile phone 3 displays the received one-time password on the display thereof (step S117). The user then enters the user ID which the user keeps in mind into the ID box 101 on the authentication screen 100 shown in FIG. 5, and the one-time password displayed on the display of the mobile phone 3 into the password box 102, and clicks the authentication button 104. With this operation, the user terminal 2 obtains the user ID and the one-time password (step S118), and sends this obtained information data and the session ID (a) of the Web server 4 obtained in step S102 to the Web server 4 (step S119).

When the Web server 4 receives the user ID, the one-time password and the session ID (step S120), the Web server 4 references the user management information 41, identifies the user using the obtained user ID, and determines whether the one-time password and the session ID obtained in step S115 and sent from the password issuing server 5, and the one-time password and the session ID obtained in step S120 and sent from the user terminal 2 are identical or not (step S121).

As a result of determination in step S121, when the one-time passwords and the session IDs are not identical (‘No’ in step S121), the Web server 4 determines that an error occurs, and the process returns to step S102 (step S122). Then the Web server 4 sends the authentication screen 100 containing a newly generated two-dimensional code 103 to the user terminal 2 to attempt the authentication again.

On the other hand, when the one-time passwords are identical, and the session IDs are also identical (‘Yes’ in step S121), the Web server 4 determines that the authentication is successfully conducted, and permits the access of the user via the user terminal 2 (step S123). Thus the user can receive a desired service provided by the Web server 4 via the user terminal 2.

As described above, in the user authentication system 1 according to this embodiment, the mobile phone 3 is used to connect to the password issuing server 5 using a two-dimensional code issued by the Web server 4, and the Web server 4 determines whether the mobile phone is registered or not using the cookie data of the mobile phone 3. Then the Web server 4 conducts operations for the user authentication using the one-time password issued by the password issuing server 5. With this operation, even when a stolen user ID is misused, a login to the Web server 4 is impossible, unless the mobile phone 3 registered by the user is used, and therefore, the security can be ensured at a level as high as that obtained when a hardware token is employed. Additionally, the authentication can be conducted by entering a user ID uniquely assigned to each user and a one-time password displayed on the display of the mobile phone 3, onto the authentication screen 100, which avoids the need for a user to keep a complicated password in mind, and significantly reduces the user's load of operations necessary for login.

In this embodiment, a case is assumed in which each of the programs for making the Web server 4 and the password issuing server 5 operate is stored in a hard disk drive. Those programs are read from a CD-ROM with the programs stored therein, and are then installed in the hard disk drive. Besides the CD-ROM, the programs may be installed from a recording medium with the programs stored therein in a computer-readable manner, such as a flexible disk and an IC card. Further, the programs may be downloaded via a communication line.

In this embodiment, a case is assumed in which the Web server 4 generates a two-dimensional code, however, the generated code may be a one-dimensional or any other code.

The embodiment of the present invention is described above, however, the present invention is not limited to the above-mentioned embodiment. Various changes can be made within a range not departing from the gist of the present invention.

For example, in the embodiment above, the Web server 4 and the password issuing server 5 are separate servers, however, the configuration is allowable in which the Web server 4 and the password issuing server 5 are integrated into one server, providing the Web server 4 with the function of the password issuing server 5.

Additionally, for example, in a case where even higher-level security is required, the present invention can be carried out in combination with the authentication using a password(s) according to the conventional technology.

1. A user authentication system comprising: a user terminal for entering information data for user authentication; a mobile phone provided with a camera and decoding a code input from the camera; a password issuing unit for generating a one-time password; and a service providing unit for providing service to the user terminal and conducting operations for user authentication, which are connected to each other,
wherein, when the user accesses the system via the user terminal, the service providing unit generates an encoded code with connection information of the password issuing unit contained therein; and sends the code to the user terminal,
wherein the mobile phone decodes the code displayed on the user terminal; and accesses the password issuing unit using the connection information,
wherein the password issuing unit generates a random one-time password; and sends the one-time password to the service providing unit and also to the mobile phone accessing the password issuing unit,
wherein the user terminal obtains the one-time password displayed on the mobile phone and user identification information for identifying the user; and sends the one-time password and the user identification information as data of authentication information to the service providing unit, and
wherein the service providing unit determines whether the one-time password sent from the user terminal is identical with the one-time password sent from the password issuing unit or not; and, if both the two passwords are determined to be identical, the service providing unit permits the access of the user via the user terminal.

2. The user authentication system according to claim 1,
wherein the service providing unit generates a session ID for identifying a session between the user terminal and the service providing unit; sends the session ID to the user terminal; and encodes the session ID in the code,
wherein, when the mobile phone accesses the password issuing unit, the mobile phone sends the session ID,
wherein, when the password issuing unit sends the one-time password to the service providing unit, the password issuing unit also sends the session ID to the service providing unit,
wherein, when the user terminal sends the one-time password and the user identification information to the service providing unit, the user terminal also sends the session ID to the service providing unit, and
wherein the service providing unit compares the two one-time passwords associated with each other, based on the session ID sent from the password issuing unit and the session ID sent from the user terminal.

3. The user authentication system according to claim 2,
wherein the mobile phone stores therein data on mobile phone identification information for identifying this mobile phone, and
wherein, when the mobile phone accesses the password issuing unit, the password issuing unit in which all users' data on the mobile phone identification information is stored in advance requests the mobile phone to send the user's data on the mobile phone identification information; when the password issuing unit receives the user's data on the mobile phone identification information from the mobile phone, the password issuing unit compares the received user's data on the mobile phone identification information with all users' data on the mobile phone identification information stored therein; and, when there is any identical data in the mobile phone identification information, the present invention sends the one-time password to the mobile phone.

4. The user authentication system according to claim 3,
wherein the data on the mobile phone identification information is the phone number of the mobile phone, and
wherein, when the password issuing unit sends the one-time password to the mobile phone, the password issuing unit sends the one-time password via a telephone network.

5. The user authentication system according to claim 2,
wherein, when the service providing unit in which all users' data on the user identification information is stored in advance receives the user's data on the authentication information from the user terminal, the service providing unit compares the user's data on the user identification information contained in the authentication information, with all users' data on the user identification information stored in the service providing unit; and, if there is an identical data in the user identification information, the service providing unit compares the two one-time passwords.

6. A user authentication method in a user authentication system comprising: a user terminal for entering information data for user authentication; a mobile phone provided with a camera and decoding a code inputted from the camera; a password issuing unit for generating a one-time password; and a service providing unit for providing service to the user terminal and conducting operations for user authentication, which are connected to each other, the user authentication method comprising:
(a) the step in which, when the user accesses the system via the user terminal, the service providing unit generates an encoded code with connection information of the password issuing unit contained therein; and sends the code to the user terminal,
(b) the step in which the mobile phone obtains and decodes the code displayed on the user terminal; and accesses the password issuing unit using the connection information,
(c) the step in which the password issuing unit generates a random one-time password; and sends the one-time password to the service providing unit and also to the mobile phone accessing the password issuing unit,
(d) the step in which the user terminal obtains the one-time password displayed on the mobile phone and user identification information for identifying the user; and sends the one-time password and the user identification information as the authentication information to the service providing unit, and
(e) the step in which the service providing unit compares the one-time password sent from the user terminal with the one-time password sent from the password issuing unit; and, when the two one-time passwords are identical, the service providing unit permits the access of the user via the user terminal.

7. The user authentication method according to claim 6,
wherein, in the step (a), the service providing unit generates a session ID for identifying a session between the user terminal and the service providing unit; sends the session ID to the user terminal; and encodes the session ID in the code,
wherein, in the step (b), the mobile phone further sends the session ID,
wherein, in the step (c), the password issuing unit further sends the session ID obtained in the step (b) to the service providing unit,
wherein, in the step (d), the user terminal further sends the session ID obtained in the step (a), and
wherein, in the step (e), the service providing unit compares the two one-time passwords associated with each other, based on the session ID sent from the password issuing unit and the session ID sent from the user terminal.

8. The user authentication method according to claim 7,
wherein the mobile phone stores therein data on mobile phone identification information for identifying this mobile phone, and the password issuing unit stores therein in advance all users' data on the mobile phone identification information, and
wherein, in the step (c), the password issuing unit requests the mobile phone accessing the system to send the user's data on the mobile phone identification information; when the password issuing unit receives the user's data on the mobile phone identification information from the mobile phone, the password issuing unit compares the received user's data on mobile phone identification information with all users' data on the mobile phone identification information stored in the password issuing unit; and, when there is an identical data in the mobile phone identification information, the password issuing unit sends the one-time password to the service providing unit and the mobile phone.

9. The user authentication method according to claim 8,
wherein the data on the mobile phone identification information is the phone number of the mobile phone, and
wherein, in the step (c), when the password issuing unit sends the one-time password to the mobile phone, the password issuing unit sends the one-time password via a telephone network.

10. The user authentication method according to claim 7, wherein the service providing unit stores therein all users' data on the user identification information in advance, and
wherein, in the step (e), the service providing unit compares the user's data on the user identification information contained in the authentication information with all users' data on the user identification information stored in the service providing unit; and, when there is an identical data in the user identification information, the service providing unit further compares the one-time passwords.
